(19) United States
(12) Patent Application Publication
(10) Pub. No.: US 2003/0030733 A1
(43) Pub. Date: Feb. 13, 2003

(54) System and method for synchronization of media data

(76) Inventors: Mark D. Seaman, Greeley, CO (US); Eric E. Williams, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/924,741

(22) Filed: Aug. 8, 2001

(51) Int. Cl. H04N 5/262

(52) U.S. Cl. 348/239

(57) ABSTRACT

A method, device, and logic for synchronizing captured data from a recorder, such as image data from a digital camera, with stored data in a storage medium. The system includes determining whether any two sets of the captured and stored data have the same first data attribute, further determining whether any two captured and stored data sets having the same first attribute at the same second and third attributes, and deleting captured data sets having the same first, second, and third data attributes. The first data attribute may be a non-calculated data attribute, such as the size, name, and time. At least one of the second and third data attributes is preferably a calculated data attribute, such as a checksum.

### COPYRIGHT NOTICE

A portion of this document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The technology disclosed here generally relates to data synchronization, and more particularly, to synchronization of captured media data from a source of audio and/or video information with stored data in a storage medium.

### BACKGROUND

Data collections including audio and/or visual “media” data are becoming larger and more common. Due to improvements in digital storage and transmission technologies, additional data can often be easily added to these collections using simple connections to a variety of media players and recorders, such as digital cameras and camcorders, audio and video recorders, scanners, copiers, compact disks, radio and television receivers, and other sources of audio and/or video information. Data is typically captured by one of these devices and then stored with other data in the media database. As with traditional alphanumeric databases, duplicate or redundant information is also undesirable in a media database. However, due to the size and complexity of many media collections, and the many forms of media data that are available, it can be quite difficult to identify duplicate records in a media database.

The managers of large multimedia asset collections often try to prevent duplicative data from being entered into their collections by manually reviewing each new image, audio/video segment, or other “media data set” as it is being added to the collection. However, the new data set must often be added to the collection before it can be adequately formatted and compared against other data sets that were previously added to the collection. Furthermore, while potentially duplicative single images may be compared fairly quickly, duplicative audio, video, or multimedia segments are much more difficult to detect since an entire segment must be viewed and/or heard in order to confirm that no part of the segment contains new data. Thus, such manual inspections of each new media data set can be very labor-intensive and time-consuming.

One technique for automatically removing duplicate data sets from a digital media collection is to perform a bit-by-bit comparison of every record in the database. However, such techniques are computationally expensive and, therefore, unacceptable for large media data collections.

### SUMMARY

These and other drawbacks of conventional technology are addressed here by providing a system and method of synchronizing captured data from a recorder with stored data in a storage medium. The method comprises the steps of determining whether any set of the captured data and set of the stored data have the same first attribute, further determining whether any captured data sets and stored data sets having the same first attribute also have the same second and third attributes, and deleting captured data sets having at least the same first and second data attributes as a stored data set. Also disclosed is a computer readable medium for synchronizing captured image data with stored image data in a storage medium. The computer readable medium comprises logic for determining whether any set of the captured data and a set of the stored image data have a same size attribute, logic for determining whether any set of the captured data and any set of the stored data having the same size attribute also have at least two other data attributes that are the same and logic for deleting the captured data sets having the same size attribute and two other attributes.

### BRIEF DESCRIPTION OF THE DRAWINGS

The invention will now be described with reference to the following drawings where the components are not necessarily drawn to scale.

FIG. 1 is a schematic diagram of an architecture for implementing an embodiment of the present invention.

FIG. 2 is a layout diagram of exemplary hardware components using the architecture shown in FIG. 1.

FIG. 3 is an illustrative flow diagram for the synchronization system shown in FIG. 1.

FIG. 4 is a flow diagram for the first phase of another embodiment of the present invention.

FIG. 5 is a flow diagram for the second phase of the embodiment disclosed in FIG. 4.

### DETAILED DESCRIPTION OF THE PREFERRED EMBODIMENTS

The synchronization functionality of the present invention described herein may be implemented in a wide variety of electrical, electronic, computer, mechanical, and/or manual configurations. In a preferred embodiment, the invention is at least partially computerized with various aspects being implemented by software, firmware, hardware, or a combination thereof. For example, the software may be a program that is executed by a special purpose or general-purpose digital computer, such as a personal computer (PC, IBM-compatible, Apple-compatible, or otherwise), workstation, minicomputer, or mainframe computer.

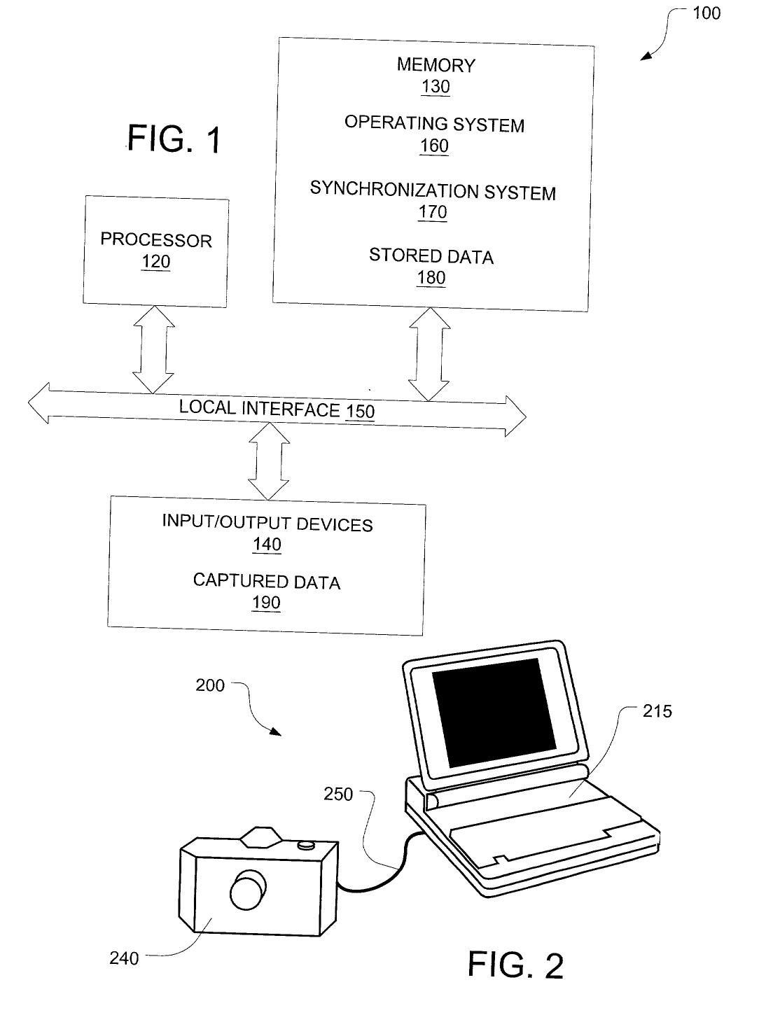

FIG. 1 is a schematic diagram of one architecture for implementing an embodiment of the present invention on a general purpose computer 100. However, a variety of other computers and/or architectures may also be used. In terms of hardware architecture, the computer 100 includes a processor 120, memory 130, and one or more input and/or output (“I/O”) devices (or peripherals) 140 that are communicatively coupled via a local interface 150.

The local interface 150 may include one or more busses, or other wired and/or wireless connections, as is known in the art. Although not specifically shown in FIG. 1, the local interface 150 may also have other communication elements, such as controllers, buffers (caches), drivers, repeaters, and/or receivers. Various address, control, and/or data connections may also be provided in the local interface 150 for enabling communications among the various components of the computer 100.

The I/O devices 140 may include input devices such as a keyboard, mouse, scanner, microphone, and output devices such as a printer or display. The I/O devices 140 may further include devices that communicate both inputs and outputs, such as modulator/demodulators (“modems”) for accessing another device, system, or network; transceivers, including radio frequency (“RF”) transceivers such as Bluetooth® and optical transceivers; telephonic interfaces; bridges; and routers. A variety of other input and/or output devices may also be used, including devices that capture and/or record media data, such as cameras, video recorders, audio recorders, scanners, and some personal digital assistants.

The memory 130 may have volatile memory elements (e.g., random access memory, or “RAM,” such as DRAM, SRAM, etc.), nonvolatile memory elements (e.g., hard drive, tape, read only memory, or “ROM,” CDROM, etc.), or any combination thereof. The memory 130 may also incorporate electronic, magnetic, optical, and/or other types of storage devices. A distributed memory architecture, where various memory components are situated remote from one another may also be used.

The processor 120 is a hardware device for executing software that is stored in the memory 130. The processor 120 can be any custom-made or commercially-available processor, including semiconductor-based microprocessors (in the form of a microchip) and/or macroprocessors. The processor 120 may be a central processing unit (“CPU”) or an auxiliary processor among several processors associated with the computer 100. Examples of suitable commercially-available microprocessors include, but are not limited to, the PA-RISC series of microprocessors from Hewlett-Packard Company, the 80×86 and Pentium series of microprocessors from Intel Corporation, PowerPC microprocessors from IBM, U.S.A., Sparc microprocessors from Sun Microsystems, Inc, and the 68xxx series of microprocessors from Motorola Corporation.

The memory 130 stores software in the form of instructions and/or data for use by the processor 120. The instructions will generally include one or more separate programs, each of which comprises an ordered listing of executable instructions for implementing one or more logical functions. The data will generally include a collection of one or more stored media data sets corresponding to separate images, audio or video segments, and/or multimedia clips that have been stored. In the example shown in FIG. 1, the software contained in the memory 130 includes a suitable operating system (“O/S”) 160, along with the synchronization system 170 and stored data 180 described in more detail below.

The I/O devices 140 may also include memory and/or a processor (not specifically shown in FIG. 1). As with the memory 130, any I/O memory (not shown) will also store software with instructions and/or data. For I/O devices 140 that capture media data, this software will include captured data 190 that has been captured, or recorded, by the I/0 device. However, the captured data 190 may also be stored in other memory elements, such as memory 130. For example, the I/0 devices may simply capture (but not record) media data on the fly and then send that captured data to another input/output device 140, memory 130, or other memory elements, where it is recorded. Some or all of the operating system 160, the synchronization system 170, and/or the stored data 180 may be stored in memory (not shown) associated with the input/out devices 140.

The operating system 160 controls the execution of other computer programs, such as the synchronization system 170, and provides scheduling, input-output control, file and data (180, 190) management, memory management, communication control, and other related services. Various commercially-available operating systems 160 may be used, including, but not limited to, the Windows operating system from Microsoft Corporation, the NetWare operating system from Novell, Inc., and various UNIX operating systems available from vendors such as Hewlett-Packard Company, Sun Microsystems, Inc., and AT&T Corporation.

In the architecture shown in FIG. 1, the synchronization system 170 may be a source program (or “source code”), executable program (“object code”), script, or any other entity comprising a set of instructions to be performed. In order to work with a particular operating system 160, source code will typically be translated into object code via a conventional compiler, assembler, interpreter, or the like, which may (or may not) be included within the memory 130. The synchronization system 170 may be written using an object oriented programming language having classes of data and methods, and/or a procedure programming language, having routines, subroutines, and/or functions. For example, suitable programming languages include, but are not limited to, C, C++, Pascal, Basic, Fortran, Cobol, Perl, Java, and Ada.

When the synchronization system 170 is implemented in software, as is shown in FIG. 1, it can be stored on any computer readable medium for use by, or in connection with, any computer-related system or method, such as the computer 100. In the context of this document, a “computer readable medium” includes any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium include an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in a the memory 130.

In another embodiment, where the synchronization system 170 is at least partially implemented in hardware, the system may be implemented in a variety of technologies including, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

FIG. 2 shows a physical layout of one exemplary set of hardware components using the computer architecture shown in FIG. 1. In FIG. 2, the home computer system 200 includes a “laptop” computer 215 containing the processor 120 and memory 130 that are shown FIG. 1. Memory 130 in the laptop 215 typically includes the O/S 160, along with the synchronization system 170 and stored data 180 that are also shown in FIG. 1. At least one of the input/output devices 140 (FIG. 1), is a data capture device, and preferably a media data recorder, such as the digital camera 240 shown in FIG.2. The digital camera 240 is connected to the laptop by an interface 150 (FIG. 1), such as the cable 250 shown in FIG. 2. The camera 240 typically contains captured media data 190 (FIG. 1) that has preferably been recorded in local memory. The synchronization system 170 then enables the computer system 200 to synchronize the captured media data 190 with the stored media data 180. Although the invention is described here with regard to a digital camera 240, it may also be applied to other devices including fax machines, scanners, personal digital assistants, multi-function devices, and sound recorders.

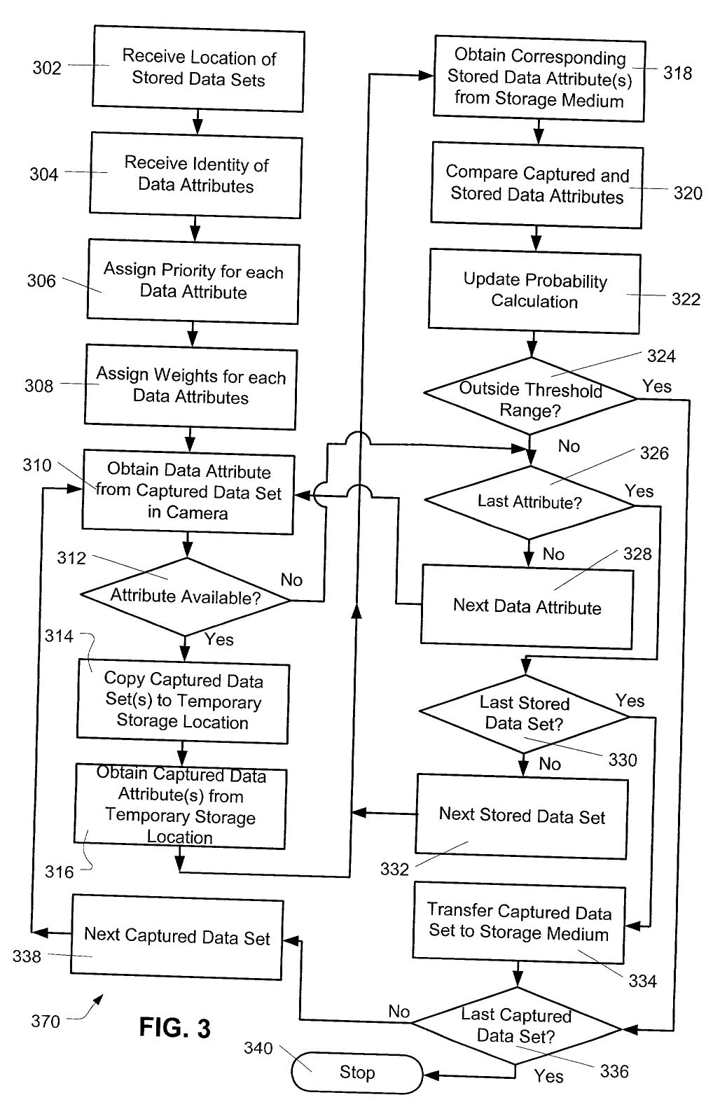

FIG. 3 is a flow diagram for one embodiment of the synchronization system 170 shown in FIG. 1. More specifically, FIG. 3 shows the architecture, functionality, and operation of a software synchronization system 170 that may be implemented with the computer system 100 shown in FIG. 1, such as the home computer system 200 shown in FIG.2. However, as noted above, a variety of other of computer, electrical, electronic, mechanical, and/or manual systems may also be similarly configured.

Each block in FIG. 3 represents an activity, step, module, segment, or portion of computer code that will typically comprise one or more executable instructions for implementing the specified logical function(s). It should also be noted that, in various alternative implementations, the functions noted in the blocks will occur out of the order noted in FIG. 3. For example, multiple functions in different blocks may be executed substantially concurrently, in a different order, incompletely, or over an extended period of time, depending upon the functionality involved. Various steps may also be manually completed.

In FIG. 3, the software system 370 first receives or automatically identifies the location of one or more sets of the stored data 180 at step 302. For example, the stored data sets might be located in the memory 130 or an I/O device 140 associated with the computer system 100 shown in FIG. 1. The location of the stored data sets could be received from a variety of sources, including an operator using the computer 100. Alternatively, or in combination with operator intervention, the location of the stored data sets may be received from the I/O device 140 (such as the camera 240), the synchronization system 170 itself, or a file searching algorithm. The location of the stored data sets will generally correspond to filenames of various audio, video, graphic, and/or other media data. For data that is organized in a database, these locations may also correspond to the identification of particular records in the data base, rather than files in a folder.

Once the location of the stored data sets has been received, the identity of one or more attributes of that data may be received or identified at step 304. The term “data attribute” is used here broadly to describe a characteristic of a data set. For example, the data attribute may contain structural information about the data that describes its context and/or meaning. Particularly useful data attributes include data type, field length, file name, file size, file creation date, file creation time, and a summary representation of the data in the data set, such as a checksum or “thumbnail” of graphic image the data. The system may also use different data attributes for each type of media data depending upon the type of data that is likely to be encountered.

The identified data attributes may then be assigned, received or otherwise associated with, priorities at step 306. For example, the priority data may be saved in memory or an operator may be prompted to provide this information. In a preferred embodiment, these priorities will define the order in which the data attributes are considered during a probability analysis discussed in more detail below. For example, data attributes that can be accessed quickly may be given the highest priority so as to increase the speed of the process. Alternatively, each data attribute may be consecutively arranged by importance to the probability calculation as discussed in more detail below with regard to attribute weights. The priorities may also be different for various types of media such as audio, video, and graphic media.

The data attributes are preferably assigned, or associated with, weights at step 308. As with the priorities at step 306, the weights at step 308 may also be assigned by an operator or set to default values that may be contained in the memory 130. For example, the weighting of each attribute may correspond to its numerical sequence in priority, or vice versa. Alternatively, certain data attributes may have a high priority but a correspondingly low weight, and vice versa. Data attributes may also be given such a low weight that they are effectively removed from the probability calculation discussed in more detail below.

The identification, prioritization, and weighting of the data attributes allows the system 370 to be optimized for the computer 100, I/O devices 140, software 170 and 180, and/or users for various types of media data and hardware configurations. However, these parameters may also be set by default values contained in the software, or eliminated, if optimization is not important.

As noted above, the data attributes will preferably be prioritized according to the speed at which they can be obtained and analyzed by the computer system 100. For example, a file creation date can often be obtained very quickly and may therefore be given a high priority. Conversely, a significant amount of computer resources may be required in order to obtain a summary representation of that data set. Consequently, summary representations (such as thumbnail images) may be given a low priority.

Weights are preferably assigned according the relevance of the data attribute for determining when a set of the captured data 190 is the same as, or substantially similar to, a set of the stored data 180. For example, the file creation date attribute may be assigned a relatively low weight since it is possible that two different sets of media data will be added to memory on the same day. On the other hand, the filename attribute may be given a high weight if it is unlikely that the camera 240 will assign the same name to different data sets that are captured on the same day.

Once the data attributes have been identified, prioritized, and weighted at steps 304-308, an attempt is made at step 310 to read, or otherwise receive, the first data attribute from the first captured data set in the captured data 190. For digital still cameras, the first captured data set may correspond to the oldest or newest image in the camera. In a preferred embodiment, the first data attribute will be the one with the highest priority from step 306.

It is possible that the computer 100 will not be able to obtain the highest priority captured data attribute directly from the camera 240 (or other I/O device 140). If an unsuccessful attempt at reading one ore more of the data attributes from the first data set directly from the camera 240 is detected at step 312, then the operator may be given suggestions for adjusting the hardware configuration in order to obtain a successful read of the data attribute(s). Alternatively, the unreadable attribute for the captured data 190 may simply be skipped, and the procedure continued with the next data attribute in the priority list from step 306.

However, in a preferred embodiment, a successful read attempt at step 312 will cause the captured data 190 to receive further processing at steps 314 and 316. At step 314 some or all of the first captured data set is transferred from the camera 240 into a temporary storage location in memory 30, or other temporary storage location. For example, a single audio or video clip, or a single image, may be downloaded to memory on the computer 100, or an empty storage location in an external I/O storage device 140. Alternatively, some or all of the sets captured data 180 may be transferred into the temporary storage location.

At step 316, the highest priority captured data attribute is then read, or otherwise received, from the (first) captured data set at the temporary storage location. For example, a file creation date may obtained from the temporary storage location. At step 318, a corresponding stored data attribute is obtained from the (first) stored data set in memory 130. For example, a creation date may be read from the youngest, oldest, or closest of the files whose location was identified at step 302. Alternatively, some or all of the data attributes may be read at substantially the same time for some or all of the captured and/or stored data sets.

At step 320, the pair of attributes from the (first) set of captured data 190 and stored data 180 are compared. For example, if the file creation dates for the captured and stored data sets are the same, then it is quite possible that adding this portion of the captured media data 190 from the camera 240 (or temporary storage location) to the stored data 180 in the memory 30 will result in duplication of data that was previously-added to the memory during the same day. However, the captured media data 190 may also be from a different photography session on the same day, and therefore not duplicative. Therefore, in order to improve the probability analysis, a comparison is made of several media and stored data attributes for each pair of captured and stored data sets. For example, in addition to a file creation date, a filename of the first set of the captured data 190 may also be compared to a filename of the first set of the stored data 180.

At step 322 one, some, or all of the attributes for the first pair of data sets are considered in a first probability calculation. In a preferred embodiment, the probability calculation is designed so as to provide a high probability that a captured data set is the same as, or substantially similar to, a stored data set whenever there is little or no difference between the captured and stored data attribute(s) compared at step 320. The probability calculation at step 322 may be a simple binary comparison of one, some, or all, of the captured data attributes and corresponding stored data attributes identified at step 304 for any pair of data sets. For example, the probability calculation 322 may simply identify a single pair of attributes, or tabulate the number of multiple data attribute pairs, that are the same (or substantially similar) for a pair of data sets from the captured and stored data 180, 190. However, since some data attributes may be more predictive of duplicate data sets than others, the probability calculation for any data set is also preferably a function of multiple data attributes and the weights and/or priorities assigned to those attributes in steps 306 and 308.

At step 324, a decision is made as to whether the probability calculation for the pair of data sets under consideration is outside of a threshold range. For example, the calculated probability may be low enough to indicate that consideration of additional attributes will not cause the probability calculation to fall outside of the threshold range. This threshold range may be above or below a 100% probability; and other yardsticks, besides attribute counts or percentages, may also be used. The threshold may be set along with the identity, priority, or weight of the various data attributes at steps 304-308. If the result of the probability calculation at step 322 is outside of the threshold range at step 324, then the captured data 190 in the captured data set under consideration is assumed to be sufficiently similar to the stored data 180 in the stored data set, that it should not be added to the stored data 180. The remaining steps shown in FIG. 3 illustrate one embodiment for sequentially updating the probability calculation at step 322 for a plurality of captured and stored data attributes, and then making a new probability calculation for each pair of captured and stored data sets, until all data attributes have been considered for all data sets.

At step 326, a decision is made as to whether there are any additional attributes that can be used to update the probability calculation for a particular pair of data sets at step 322. If other attributes are available, then the next captured data attribute (preferably in order of the priorities set at step 306) is chosen at step 328 and read from either an I/O device 140 (such as camera 240) at step 310 or the temporary storage location at step 316. Steps 318-326 are then repeated for the second attribute and the probability calculation is sequentially updated for each new data attribute comparison until all attributes have been considered at step 326.

Once the last attribute has been considered for a particular captured data set, a decision will be made at step 330 as to whether the captured data set has been compared to all of the stored data sets. If there are other stored data sets identified at step 302 for which the media and stored data attribute(s) have not yet been compared at step 318, then the next stored data set is chosen at step 332 and the system returns to step 318. Alternatively, if no duplicates are found, then the captured data set is transferred to the storage medium at step 334. Once all of the stored data sets have been considered for a particular captured data set, then the next captured data set is selected at step 338 and the process returns to step 310 until a decision that all of the sets of captured data 190 been considered is made at step 336, and the process is stopped at step 340.

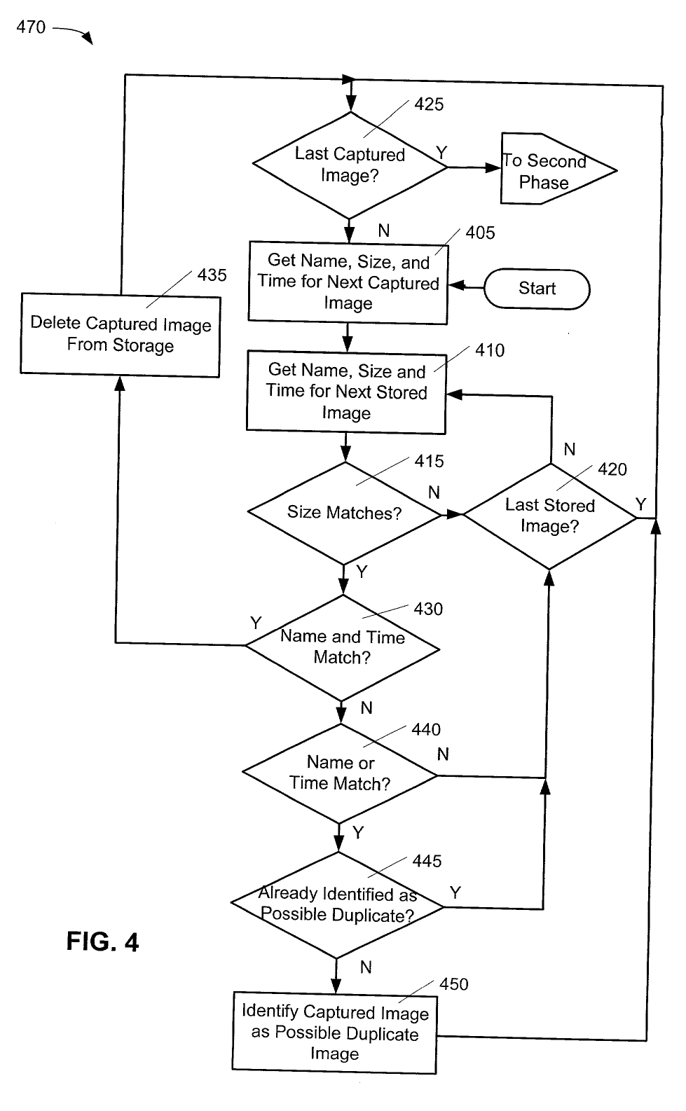

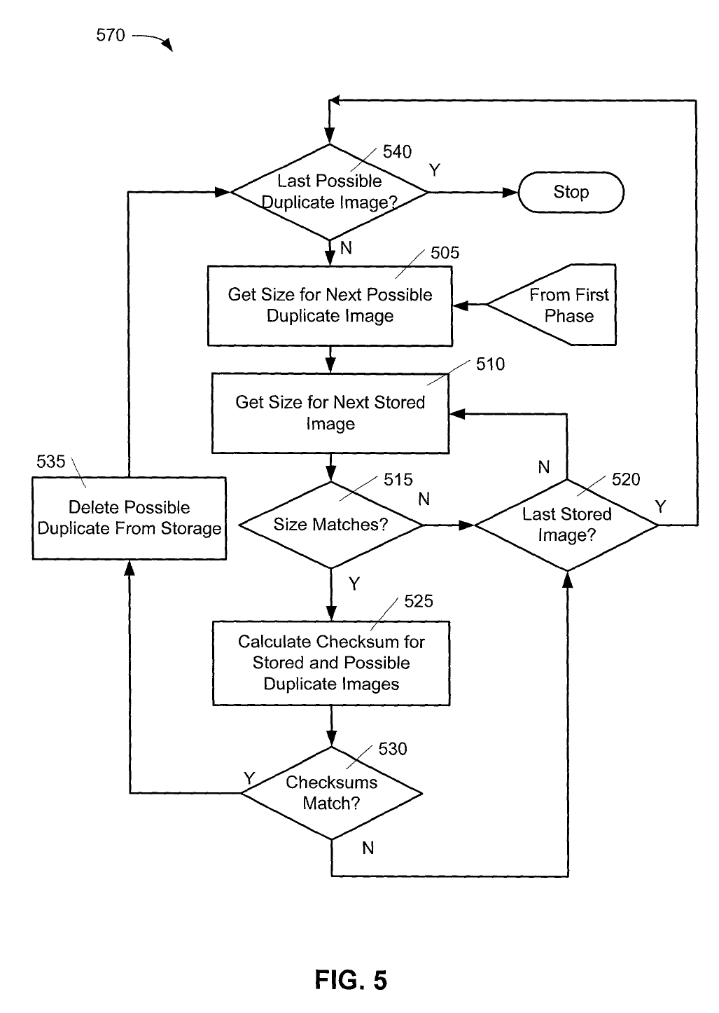

FIGS. 4 and 5 are a flow diagram for another embodiment of the synchronization system 170 shown in FIG. 1 that may be implemented with some or all components shown in FIG. 2. In particular, FIG. 4 illustrates a first phase 470 of this embodiment of the synchronization system, while FIG. 5 illustrates a second phase 570 of the same synchronization system. A computer code sequence listing for implementing the embodiments shown in FIGS. 4 and 5 is appended to this document.

As in FIG. 3, each block in FIGS. 4 and 5 represents an activity, step, module, segment, with a portion of computer code that will typically comprise one or more executable instructions for implementing the specified logical function(s). It should also be noted that, in various alternative implementations, the functions noted in the blocks will occur out of the order noted in FIGS. 4 and 5. For example, multiple functions in different blocks may be executed substantially concurrently, in a different order, incompletely, or over an extended period of time, depending on the functionality involved. Various steps may also be manually completed.

The synchronization shown in FIGS. 4 and 5 preferably starts when all of the captured images from the camera 240 have been downloaded into the computer 215. The first phase 470 will make a determination as to which of the captured and downloaded images is an actual duplicate or a “possible duplicate.” A possible duplicate image has at least one, but not all, of its attributes matching the attributes of another image. In order to quickly identify these possible duplicates, the first phase 470 preferably uses only “non-calculated” attributes that do not require additional computation. For example, name, size, and time will have been previously computed by the operating system in the camera 240 or computer 215 when an image is placed in or retrieved from the corresponding memory. In contrast, “calculated” attributes will have to be derived from existing information through additional computations.

Many actual duplicates will be quickly discovered in the first phase 470 without the need to calculate additional attributes. The actual duplicates will be deleted, and the possible duplicates will be further evaluated in the second phase 570 in order to determine whether they are also suitable for deletion. Once the first phase 470 and second phase 570 are completed, then the possible duplicates determined to be suitable for deletion are deleted.

In FIG. 4, the first phase 470 starts at step 405 by getting any or all of the name, size, and time for the first captured image in the camera 240 (FIG. 2). As noted above, the captured images will preferably have been previously copied, moved, or otherwise transferred from the camera 240 into the computer 215 before starting the first phase 470. Consequently, this name, size, and time information may be available from the memory 130 (FIG. 1) in the computer 215. Alternatively, this information may be downloaded directly from the camera 240 without having previously downloaded the images from the camera to the computer 215. Next, at step 410, the name, size and time for the first stored image in the computer 215 (FIG. 2) are obtained. If the size of these files is found not to match at step 415, then a determination is made at step 420 as to whether this is the last stored image for comparison. If not all of the stored images have been compared to the first captured image at step 420, then the process returns to step 410 for the next stored image until the first captured image has been compared with regard to size against all of the stored images at step 420. If the size of the captured image does not match the size of any of the stored images at step 420, then the process returns to step 425 in order to determine whether all captured images have been compared.

Returning to step 415, if there is a match between the size of the captured image under consideration and a stored image, then the process moves to step 430 in order to determine whether the name and time of the captured and stored images also match. If the name and time of the captured and stored images matches at step 430, then the captured image is assumed to be a duplicate and deleted at step 435. On the other hand, if the name and time do not both match at step 430, then a determination is made at step 440 as to whether either of the name or time match. If neither of the name or time match, then the captured image is presumed to be not already stored and the process returns to step 420.

When the first phase 470 reaches step 445, a determination has been made that the size of the captured and stored image matches, along with the name or time, but not both. Therefore, a determination is made at step 445 as to whether the captured image file has been already identified as a possible duplicate and, if not, it is so identified at step 450. The system 470 then determines whether all of the captured images have been considered at step 425 and, if so, proceeds to the second phase 570 shown in FIG. 5.

The second phase 570 starts at step 505 by obtaining the size of the first image that has been identified as a possible duplicate during the first phase 470. Next, at step 510, the size of the next stored image is obtained. Preferably, a comparison is made at step 515 in order to determine whether the size of the first possible duplicate image matches the size of the first stored image. (Alternatively, the size comparison at step 415 in FIG. 4 may be reused). If not, then the second phase 570 proceeds through step 520 until all stored images have been considered.

If the size of a possible duplicate image matches the size of a stored image, then the second phase 570 proceeds to step 525 and calculates an attribute, such as a checksum, for the stored and possible duplicate images. Note that the checksum is calculated only for images with matching sizes so as to minimize the computational time required for the second phase 570. If the checksums match, then the possible duplicate image is assumed to be a duplicate and deleted at step 535. The process then returns to step 505 unless a determination is made at step 540 that all possible duplicate images have been considered.

1. A method of synchronizing captured data from a recorder with stored data in a storage medium, comprising the steps of:
determining whether any set of the captured data and set of the stored data have the same first data attribute;
further determining whether any captured data sets and stored data sets having the same first attribute have the same second and third data attributes; and
deleting captured data sets having at least the same first, second, and third data attributes as a storage data set.

2. The method recited in claim 1, wherein the first data attribute is a non-calculated data attribute.

3. The method recited in claim 1 wherein at least one of the second and third data attributes is a calculated data attribute.

4. The method recited in claim 2, wherein the non-calculated data attribute is selected from the group consisting of size, name, and time.

5. The method recited in claim 2, wherein the calculated data attribute is a checksum.

6. The method recited in claim 1, wherein the first data attribute is size.

7. The method recited in claim 1, wherein the second and third data attributes are selected from the groups consisting of name, time and checksum.

8. A computer readable medium for synchronizing captured image data with stored image data in a storage medium, comprising:
logic for determining whether any set of the captured and set of the stored image data have a same size attribute;
logic for further determining whether captured data sets and stored data sets having the same size attribute also have at least two other data attributes that are the same; and
logic for deleting captured data sets having the same size attribute and the same two other attributes.

9. The computer readable medium of claim 8, wherein at least one of the two other data attributes includes a calculated data attribute.

10. The computer readable medium of claim 9, wherein the calculated attribute is a checksum.

11. The computer readable medium of claim 9, wherein the at least two other data attributes includes a non-calculated data attribute.

12. The computer readable medium of claim 11, wherein the non-calculated data attribute is selected from the group consisting of name and time.

13. A system for synchronizing captured image data from a camera with stored image data in a storage medium, comprising:
means for determining whether any two sets of the captured and stored image data have a same size and attribute;
means for further determining whether any two sets of captured and stored data having the same size attribute also have at least two other data attributes that are the same; and
means for deleting captured data sets having the same size and attribute.

14. The system of claim 13, further comprising means for transferring all sets of captured image data from the camera to the storage medium prior to determining whether any sets of the captured and stored image data have a same size attribute.
